(19) United States
(12) Patent Application Publication
(10) Pub. No.: US 2024/0365868 A1
(43) Pub. Date: Nov. 7, 2024

(54) Porous Element For Vaporizable Substances, Comprising a Precise-Volume Dosing Cavity

(71) Applicant: dan steinberg, blacksburg, VA (US)

(72) Inventor: dan steinberg, blacksburg, VA (US)

(21) Appl. No.: 18/653,968

(22) Filed: May 2, 2024

Related U.S. Application Data
(60) Provisional application No. 63/463,521, filed on May 2, 2023.
(60) Provisional application No. 63/549,459, filed on Feb. 3, 2024.

(51) Int. Cl. A24F 40/44; A24F 40/10; C03C 14/00; C04B 35/565; C04B 38/00

(52) U.S. Cl. CPC A24F 40/44; A24F 40/10; C03C 14/004; C04B 35/565; C04B 38/0058; C03C 2214/04; C04B 2235/3826; C04B 2235/9607

(57) ABSTRACT

Provided is a porous and heat resistant substrate for retaining meltable materials for vaporization, such as herbal extracts. The porous substrate has a cavity disposed in the surface. The cavity has a precise volume. The volume of the cavity is less than or equal to a total pore volume, which in most cases is equal to the total liquid absorption capacity of the substrate. In use, the cavity is filled with material to be vaporized, thereby providing a precise dose. When heated, the molten material flows into the substrate by capillary action.

### FIELD OF THE INVENTION

The present invention relates generally to vaporizers. More specifically, it relates to components for wicking and retaining liquid vaporizable substances, such as plant/herbal extracts.

### BACKGROUND OF THE INVENTION

Many vaporizers today are designed for use with herbal extracts (in liquid or solid form) instead of raw plant material. These extracts can be highly concentrated and therefore difficult to measure for proper dosing. Additionally, extracts can be difficult to handle because they sticky and loose. Specifically, these properties make it difficult to measure accurate doses.

In a typical vaporizer, an extracts is absorbed in a porous substrate, which is then heated. The substrate is conventionally made of tangled, and very fine stainless steel wire. Wire substrates have relatively low absorption capacity as a result of relatively large pore size. Consequently, they are easily overloaded, which results in dripping and leaking of the extract. Leaking extract can contaminate or damage a vaporizer, and create unpleasant tastes or odors over time.

Stainless steel wire substrates are difficult to clean and are therefore often treated as disposable items. There is no good method for removing polymerized or pyrolytic products that accumulate in the substate interior. This material can be removed by incineration, but the high temperatures required cause oxidation and damage to the stainless steel wire. Burned stainless steel may be a health hazard and produces unpleasant tastes and odors.

There is a long-felt need for improved substrates for vaporizing extracts.

### SUMMARY

The present invention provides an article for measuring and retaining a meltable and vaporizable material, such as a plant extract. The article comprises a porous substrate comprising a large number (e.g., greater than 500 or 1000) of mutually attached particles made of heat resistant material. Interconnected pores are disposed between the particles. The substrate has a surface and a cavity is disposed in the surface. The cavity has a predetermined volume, and the volume of the cavity is less than 115% of the total pore volume of the substrate.

Alternatively, the volume of the cavity is less than or equal to the total pore volume of the substrate. The cavity volume can be in the range of 3-100 or 5-50 microliters for example.

Heat resistant materials contemplated in the invention include titanium, stainless steel, silica, silicon carbide, aluminum oxide, or borosilicate glass.

The particles can have sizes of about 40-150 microns.

The porous substrate can also be made of other porous material structures (other than bonded particles), such as open cell foam.

### DESCRIPTION OF THE FIGURES

FIG. 1A shows a perspective view of a porous substrate according to the present invention.

FIG. 1B shows a cross-sectional side view of a porous substrate according to the present invention.

FIGS. 2A and 2B show how the cavity is filled with a rubber scraper or spatula.

FIG. 3 illustrates the material to be vaporized melting and being absorbed into the porous substrate.

FIG. 4 shows an embodiment with two cavities of different sizes.

FIG. 5 shows an embodiment with two cavities on different sides of the porous substrate.

FIG. 6 shows an embodiment with six cavities.

FIG. 7 shows an embodiment with a spiral-shaped cavity.

FIG. 8 shows an embodiment with a star shape and heat exchange fins.

FIGS. 9A, 9B, 9C show three other star shapes contemplated in the present invention.

FIGS. 10A and 10B shows an embodiment with through-holes for heat exchange.

FIG. 11 shows an embodiment with a rectangular shape and 8 parallel heat exchange fins (4 on left side and 4 on right side).

FIGS. 12A and 12B show embodiments with convex and concave surfaces where the cavity is disposed. These figs also illustrate how the cavity volume is determined.

### DETAILED DESCRIPTION

The present invention provides a porous substrate with a dose-measuring cavity. The cavity is disposed in one surface of the substrate and has a precise volume. The cavity is filled with extract material to be vaporized. The cavity can be precisely filled with the use of a rubber scraper or spatula. The porous substrate has a pore volume, which is the volume of all the pores added together. The pore volume is equal to the liquid absorption capacity of the substrate. In the present invention, the cavity volume is less than or equal to the total pore volume of the substrate. This assures that the substrate can absorb all the extract material without becoming oversaturated. In use, the porous substrate cavity is loaded with extract and then heated in a vaporizer or pipe. The extract melts from the heat, and the molten extract is absorbed into the porous substrate. Additional heating results in vaporization of the extract.

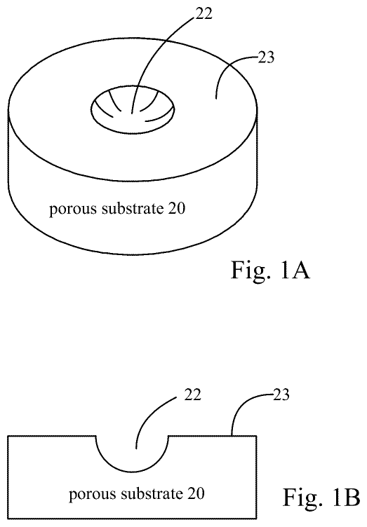

FIGS. 1A and 1B show perspective and cross-sectional side views of a porous substrate according to the present invention, respectively. A dosing cavity 22 is disposed in a surface 23 of the substrate. The surface 23 is flat. The cavity 22 has a precise, predetermined volume designed to measure a desired dose of extract or other vaporizable material to be vaporized.

The volume of the cavity is selected to hold a convenient dose of extract or other vaporizable material. For example, the cavity volume can be in the range of 2-100, 5-75 or 10-50 microliters.

The porous substrate is made of heat-resistant material. The present invention and claims do not limit the heat-resistant material comprising the porous substrate. For example, the substrate can be made of silicone carbide, borosilicate glass, aluminosilicate glass, aluminum oxide, silica, ceramics, metals, glasses, silicon nitride, or combinations thereof. The porous substrate can comprise sintered particles of ceramics, glasses or metals. For example, the porous substrate can comprise a mixture of silicon carbide and borosilicate glass particles, sintered such that the silicon carbide particles are bonded by the borosilicate glass (i.e., the borosilicate glass functions as a sintering aid). Alternatively, titanium powders or stainless steel powders can be sintered to form a porous body suitable in the present invention. Also, ceramic powders can be sintered to form the porous material. Sintering aids can be added to enhance particle bonding, as known in the art.

In embodiments where the substrate is made of bonded powders, the powder particles can have sizes in the range of about 25-250, 40-200, or 50-150 microns for example. Also, the particles can be bonded by any method, and are not necessarily bonded by sintering/heating.

Alternatively, the porous substrate can comprise open cell foam, made of ceramics, metals or glasses or other heat-resistant materials. For example, the porous substrate can be made of silicon carbide open cell foam. Also for example, the silicon carbide open cell foam can be produced by chemical vapor deposition, as known in the art.

The porous substrate may have pore sizes that are small compared to the dimensions of the cavity. For example, the pore sizes can be less than 1/10 or 1/20 or 1/40 the diameter of the cavity. Small pore sizes assure that the cavity surfaces, shape, and volume are well defined. A well-defined cavity assures a well-defined dose.

The porous substrate can have a porosity in the range of about 25-55% for example. However, porosity may be higher than 55% if the porous substrate comprises open cell foam. For example, silicon carbide open cell foam suitable in the present invention may have a porosity higher than 75 or 85%. High porosity may be desirable if fast heat-up time or minimal energy requirement for heating is preferred. Porosity is the ratio of the pore volume to the total volume of the substrate.

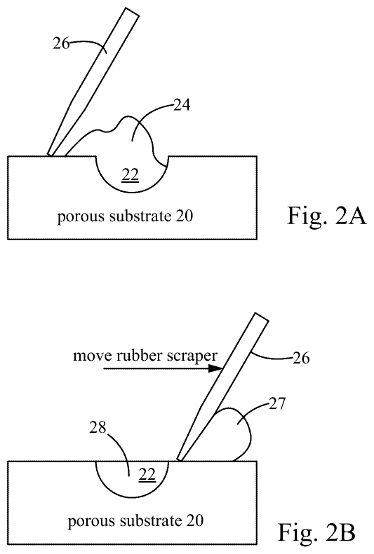

FIGS. 2A and 2B show side views illustrating how the present substrate is used. Extract or other material to be vaporized 24 is disposed in and around the cavity 22. Preferably, the material 24 has a paste-like, spreadable consistency. Vaporizable materials can be heated or mixed with softening agents (e.g. alcohols, propylene glycol, glycerin, as known in the art) to achieve the right consistency.

A rubber scraper 26 is used to press the material 24 into the cavity and completely fill the cavity. The scraper 26 removes excess material 27 such that the material surface is flush with the edges of the cavity. This provides a precise dose 28 in the cavity 22.

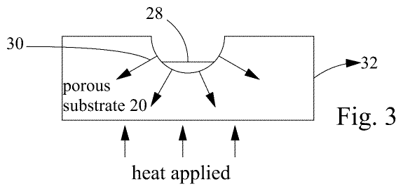

FIG. 3 shows the present porous substrate in use. Heat is applied with a suitable vaporizer or pipe (not shown), as known in the art. The heat melts the vaporizable material dose 28 in the cavity. The molten material flows 30 into the porous substrate by capillary action. With continued heating to vaporization temperatures, vapor 32 emanates from the porous substrate.

It is noted that the substrate 20 has sufficient pore volume to absorb the entire volume of the cavity. Accordingly, the porous substrate may have a total pore volume equal to or greater than the cavity volume. However, it is also noted that the substrate may also retain even larger amounts of material without dripping or leaking in some embodiments, such as if the material has a high surface tension. For this reason, the cavity volume may exceed the total pore volume of the substrate by 10%, 15% or 20% in the present invention.

It is noted that the total pore volume is easily determined by the weight increase resulting from saturating the porous substrate with water. Each milligram of weight increase indicates one microliter of pore volume. However, this method is valid only if the water completely fills all the pores. Complete pore filling requires that the porous substrate is highly wettable with water.

The porous substrates may be manufactured by conventional ceramic, glass, or metal processing methods. For example, methods for sintering porous materials made of ceramic, glass and metal powders are well known in the art. For example, the powders may be combined with a sintering aid and/or binding agent, and then calcined in air, vacuum furnace, or inert atmosphere. Also, the powders may be disposed in a graphite, boron nitride, or other nonstick mold, and heated in a vacuum furnace or inert atmosphere (e.g. nitrogen or argon). In a particular embodiment, silicon carbide and borosilicate powders are mixed and disposed in a graphite mold, which is then heated in an inert or non-oxygenated atmosphere until the borosilicate glass softens and binds the silicon carbide particles.

FIG. 4 show an embodiment with two cavities, a large-dose cavity 34, and a small dose cavity 36. Both cavities can be filled, providing a third, largest dose option. If multiple cavities are present, the substrate may be designed with enough pore volume to absorb the molten material from all the cavities.

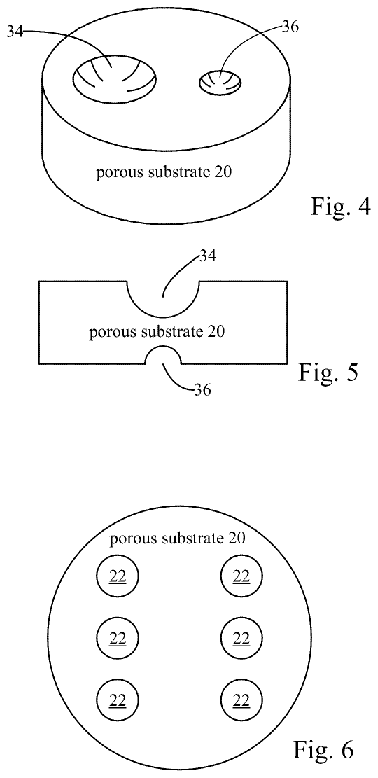

FIG. 5 shows an embodiment in which large and small cavities 34 36 are disposed on opposite sides of the substrate 20.

FIG. 6 shows a top view of an embodiment having 6 cavities. The user fills the number of cavities appropriate for a desired dose. Any number of cavities can be provided in substrates of the present invention.

Also, the cavities can have any shape, including decorative shapes. For example, the cavities can be in the shape of animals, leaves, stars, spirals, trees, plants, faces or any other shape or pattern with aesthetic appeal.

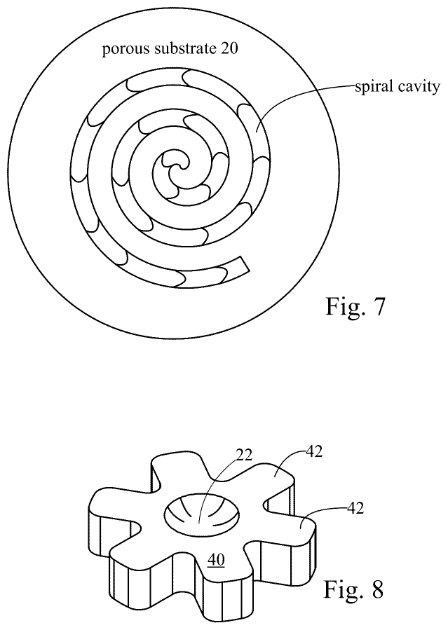

FIG. 7 shows a substrate with a spiral cavity.

Also, it is noted that the substrate can have any shape. The substrate is not necessarily cylindrical. For example, FIG. 8 shows a substrate 40 with a star shape, having radial fins 42. The fins increase the surface area of the substrate (compared to a cylindrical design), which tends to increase the rate of heating and vaporization. Star shaped porous substrates can have any number of heat exchange fins: 3, 4, 5, 7, 8, 9, or 10 fins for example.

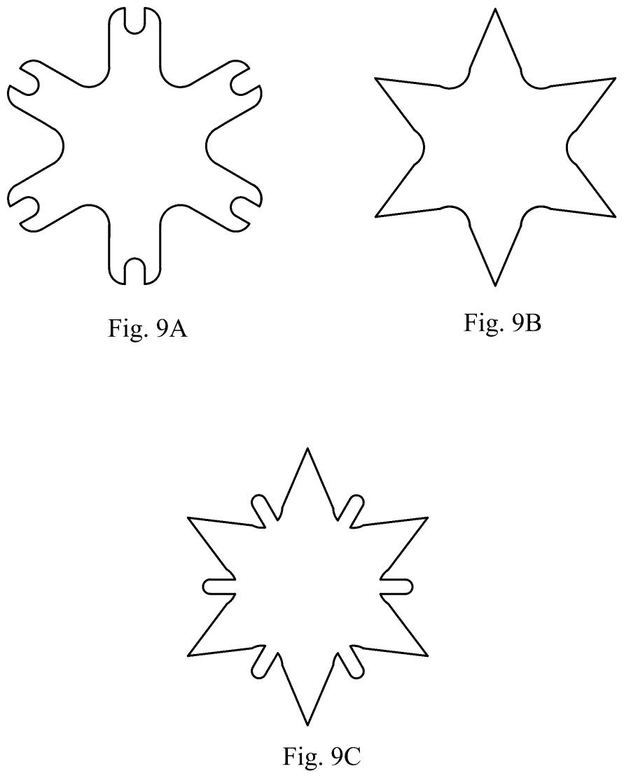

FIGS. 9A, 9B, and 9C show three other star shapes possible in the present invention.

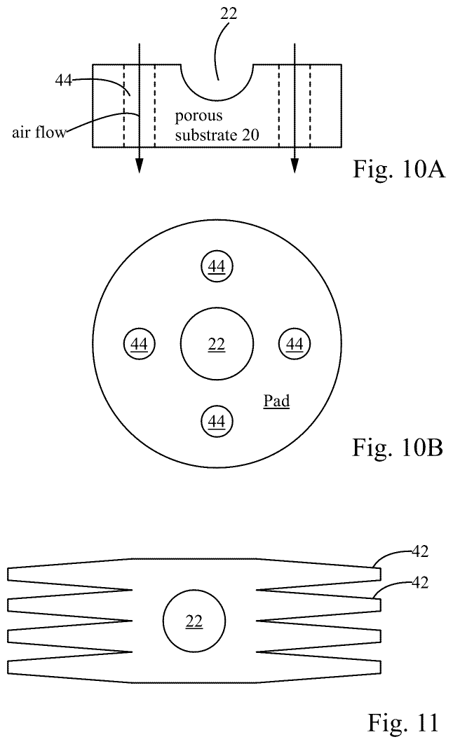

FIGS. 10A and 10B show cross sectional and top views of an embodiment having through holes 44 for air flow. The through holes 44 improve heat exchange with heated air from a vaporizer.

FIG. 11 shows an embodiment with a rectangular shape and four parallel heat exchange fins 42 on two sides.

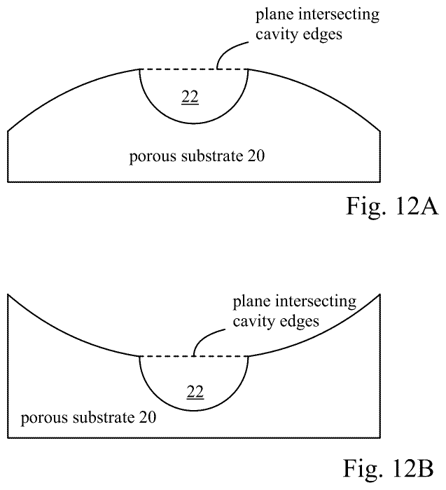

FIGS. 12A and 12B show embodiments with convex and concave surfaces where the cavity is disposed. In both cases, the cavity volume is defined by the plane or surface intersecting the cavity edges. In most cases, any may be always, this will be the same as or very close to the volume of soft material in the cavity when filled with a rubber scraper.

What is claimed is:

1. An article for measuring and retaining a meltable and vaporizable material, comprising:
a porous substrate comprising a large number of mutually attached particles made of heat-resistant material, and further comprising interconnected pores disposed between the particles, wherein the substrate has a surface; and
a cavity disposed in the surface, wherein the cavity has a predetermined volume, and
wherein the volume of the cavity is less than 115% of a total pore volume of the porous substrate.

2. The article of claim 1 wherein the volume of the cavity is less than or equal to a total pore volume of the object.

3. The article of claim 1, wherein the cavity volume is in the range of 3-100 microliters.

4. The article of claim 1, wherein the cavity volume is in the range of 5-50 microliters.

5. The article of claim 1, wherein the porous substrate has a porosity in the range of 25-55%

6. The article of claim 1, wherein the surface is flat.

7. The article of claim 1, wherein the particles are made of titanium, stainless steel, silica, silicon carbide, aluminum oxide, or borosilicate glass.

8. The article of claim 1, wherein the particles are mostly in the size range of 40-150 microns.

9. The article of claim 1, wherein the porous substrate comprises silicon carbide particles attached with borosilicate glass.

10. The article of claim 1, wherein the porous substrate has a star shape, with at least 3 heat exchange fins.

11. The article of claim 1, wherein the porous substrate has least 3 heat exchange fins.

12. An article for measuring and retaining a meltable and vaporizable substance, comprising:
a porous substrate made of heat resistant material, and wherein the substrate has a surface; and
a cavity disposed in the surface, wherein the cavity has a predetermined volume, and
wherein the volume of the cavity is less than or equal to a total pore volume of the porous substrate

13. The article of claim 12, wherein the cavity volume is in the range of 3-100 microliters.

14. The article of claim 12, wherein the cavity volume is in the range of 5-50 microliters.

15. The article of claim 12, wherein the porous substrate has a porosity in the range of 25-55%

16. The article of claim 12, wherein the heat resistant material comprises silicon carbide particles attached with borosilicate glass.

17. The article of claim 12, wherein the porous substrate has a star shape, with at least 3 heat exchange fins.

18. The article of claim 12, wherein the porous substrate has least 3 heat exchange fins.

19. An article for measuring and retaining a meltable and vaporizable substance, comprising:
a porous substrate comprising open cell foam, made of heat-resistant material, wherein the substrate has a surface;
a cavity disposed in the surface, wherein the cavity has a predetermined volume, and
wherein the volume of the cavity is less than or equal to a total pore volume of the object.

20. The article of claim 19 wherein the open cell foam has at least 100 pores per inch.

21. The article of claim 19 wherein the open cell foam is made of silicon carbide.
